(19) United States
(12) Patent Application Publication
(10) Pub. No.: US 2016/0025365 A1
(43) Pub. Date: Jan. 28, 2016

(54) SYSTEM AND METHOD FOR VARIABLE DESTINATION DELIVERY SYSTEM

(71) Applicant: Christopher Moudy, Denkingen (DE)

(72) Inventor: Christopher Moudy, Denkingen (DE)

(21) Appl. No.: 14/849,155

(22) Filed: Sep. 9, 2015

Related U.S. Application Data
(63) Continuation-in-part of application No. 13/402,805, filed on Feb. 22, 2012, now abandoned.
Application No. 13/402,805 is a continuation-in-part of application No. 12/379,771, filed on Feb. 27, 2009, now abandoned.
Application No. 12/379,771 is a continuation-in-part of application No. 11/004,075, filed on Dec. 6, 2004, now abandoned.

(51) Int. Cl. F24F 11/00; G05B 15/02; H04W 4/02

(52) U.S. Cl. CPC F24F 11/006; H04W 4/025; G05B 15/02

(57) ABSTRACT

Systems and methods for a variable destination delivery system according to various aspects of the present technology may comprise a transport box having a storage space and a plurality of electrical contacts. The transport box may be configured to fit within the interior space of a delivery box. The delivery box may comprise a plurality of corresponding electrical contacts configured to be coupled to the electrical contacts of the transport box. The delivery box may further comprise an electronic lock configured to be communicatively coupled to a delivery box controller circuit configured to operate the electronic lock. The transport box may further comprise a transport box controller circuit configured to be communicatively coupled to a heating and/or cooling device. A communication interface may be established between the transport box controller circuit and the delivery box controller circuit such that information may be shared between the transport box and the delivery box.

### CROSS-REFERENCES TO RELATED APPLICATIONS

This application is a Continuation-in-part of U.S. patent application Ser. No. 13/402,805, filed Feb. 22, 2012, which is a Continuation-in-part of application of U.S. application Ser. No. 12/379,771 filed Feb. 27, 2009, which is a Continuation-in-part of application of U.S. application Ser. No. 11/004,075 filed Dec. 6, 2004 and incorporates the disclosure of each application in its entirety by reference. To the extent that the present disclosure conflicts with any referenced application, however, the present disclosure is to be given priority.

### BACKGROUND OF INVENTION

The Internet has opened a vast electronic frontier for consumers, enabling the consumers to shop, from the convenience and comfort of their own home or business, among countless providers of all types of goods. Electronic commerce, merged with the Internet and the World Wide Web, facilitates the purchase of goods by integrating a variety of payment services so that, after browsing the Web and browsing merchant websites, goods may be purchased essentially with the click of a button.

Once an order for goods has been placed with an Internet merchant, the goods of course must be delivered to the customer. While conventional forms of delivery, including the U.S. mail, express and overnight delivery services and other forms of mail and package delivery, and other common delivery and shipping methods and services, suffice for many items ordered on the Internet, some items require special handling for proper delivery. Food or other perishable items may require special care, such as maintenance of proper temperatures during delivery and after delivery if the food items delivered are left unattended. High value items may require special handling for security, or will require insurance against the loss or theft of the items during the course of delivery. The lack of a delivery service specialized to accommodate special handling for some goods may discourage a vibrant Internet marketplace for the goods if customers are concerned about receiving goods in good condition (such as frozen food items that may arrive thawed) or if Internet merchants or their customers must bear excessive costs to insure goods for delivery. Additionally, delivery of some goods is hampered if the recipient is not present to receive the goods, since shippers and merchants are reluctant to have certain goods left unattended.

Various receptacles have been employed to receive delivered goods. A locked mailbox, for example, with a delivery slot that allows letters or very small packages to be inserted into the mailbox, and only removed by a recipient with a key. This provides a degree of security for the letters and small packages, but does not prevent receipt of unwanted items. Additionally, provision for maintaining an environmental condition is lacking. Larger lock boxes have been devised to overcome package size limitations. However, no known lock box addresses all phases of delivery of goods to provide security and proper handling of goods with special needs.

Thus a system and method for delivery of goods ordered via the Internet solving the aforementioned problems is desired.

### SUMMARY OF THE INVENTION

Systems and methods for a variable destination delivery system according to various aspects of the present technology may comprise a transport box having a storage space and a plurality of electrical contacts. The transport box may be configured to fit within the interior space of a delivery box. The delivery box may comprise a plurality of corresponding electrical contacts configured to be coupled to the electrical contacts of the transport box. The delivery box may further comprise an electronic lock configured to be communicatively coupled to a delivery box controller circuit configured to operate the electronic lock. The transport box may further comprise a transport box controller circuit configured to be communicatively coupled to a heating and/or cooling device. A communication interface may be established between the transport box controller circuit and the delivery box controller circuit such that information may be shared between the transport box and the delivery box.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates a delivery box of the variable destination delivery system;

FIG. 2 representatively illustrates a side view of the delivery box;

FIG. 3 representatively illustrates an alternative embodiment of the variable destination delivery system wherein the delivery box is affixed to a structure;

FIG. 4 representatively illustrates a transport box;

FIG. 5 representatively illustrates a block diagram of various components of the delivery box and the transport box;

FIG. 6 representatively illustrates a variable destination delivery system;

FIG. 7 representatively illustrates an exemplary method of placing an order with the variable destination delivery system;

FIG. 8 representatively illustrates an exemplary method of delivering an order with the variable destination delivery system;

FIGS. 9 and 10 representatively illustrates an exemplary method of completing a delivery using the variable destination delivery system;

FIG. 11 representatively illustrates an alternative embodiment of the delivery box; and

FIGS. 12A and 12B representatively illustrates an exemplary method of the variable destination delivery system using weights.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of computing systems, networks, software, shipment containers and techniques, and the like which may carry out a variety of functions. In addition, the present technology may be practiced in conjunction with any shipment and/or delivery system and the system described is merely one exemplary application for the technology. Further, the present technology may employ any number of conventional techniques for loading, storing, and transferring information between two electronic devices over a network, operating (i.e., locking and unlocking) an electronic lock, verifying shipping information, and/or reading specific shipping information.

Methods and apparatus for variable destination shipping according to various aspects of the present technology may operate in conjunction with any suitable computer system, network, and/or shipping container. Various representative implementations of the present technology may be applied to any system configured to facilitate the shipment and/or transportation of goods from one location to another.

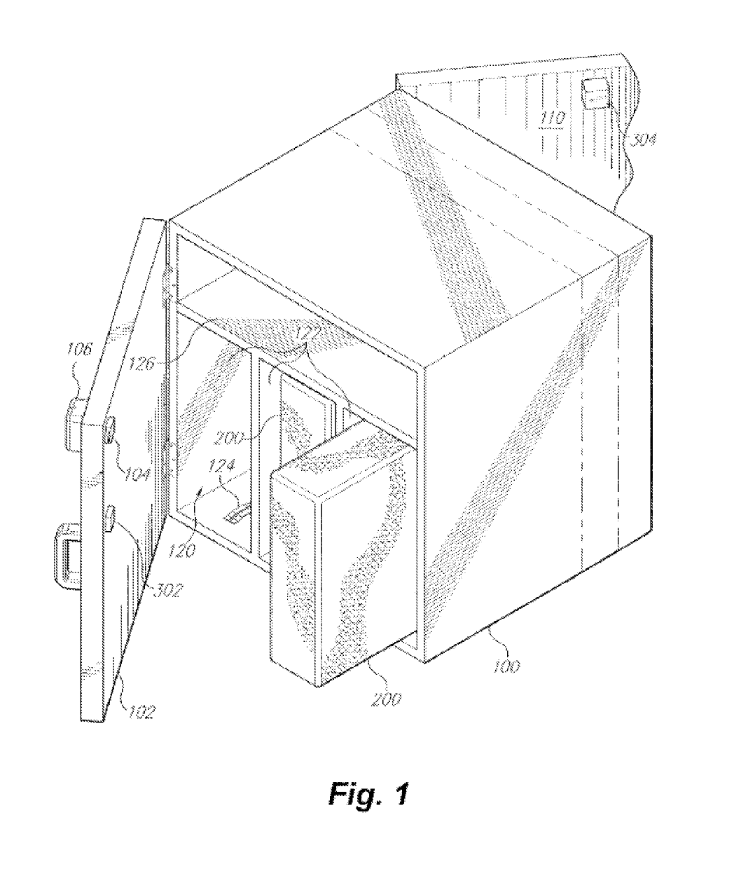

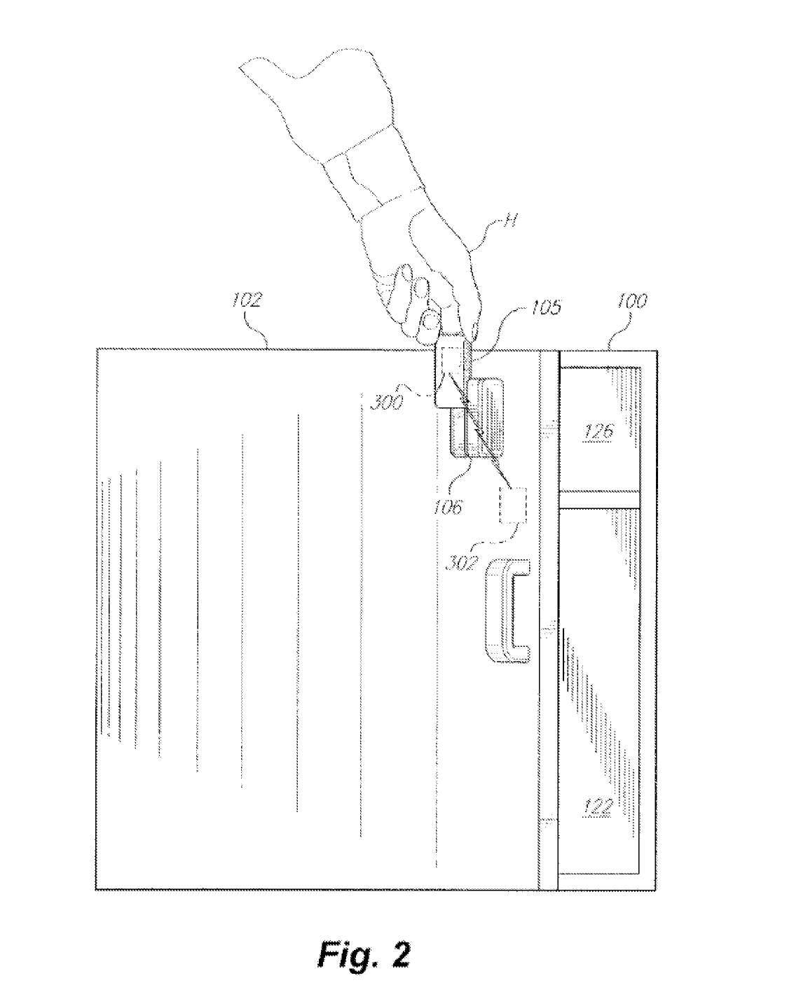

Referring to FIGS. 1-3, in one embodiment, a variable destination delivery system may be configured to utilize a delivery box 100. The delivery box 100 may comprise a front door 102. The front door 102 may be configured to be securable by an electronic lock 104. The electronic lock 104 may be configured to grant access to an delivery box interior space 120 of the delivery box 100.

In one embodiment, the electronic lock 104 may comprise any suitable system or method configured to control access to the delivery box interior space 120. For example, the electronic lock 104 may be configured to operate in conjunction with a keycard reader 106. The keycard reader 106 may be configured to read, scan, and/or otherwise retrieve information stored on a keycard 105 to gain entry to the delivery box interior space 120 via the electronic lock 104. For example, the keycard reader 106 may be configured with a slot configured to receive a keycard 105. Once the slot receives the keycard 105, the variable destination delivery system may be configured to perform an authentication process to ensure that the person and/or keycard 105 attempting to gain access to the interior space is in fact authorized to do so. For example, the authentication process may check whether the card is still active, whether a correct PIN or passcode was entered corresponding to the card, and the like.

In one embodiment, the electronic lock 104 may comprise any suitable system configured to operatively lock and/or unlock the delivery box 100. For example, the electronic lock 104 may comprise a dead bolt system, a tumbler system, or the like. The electronic lock 104 may be further configured to operate in conjunction with any suitable type of input device such as a touchscreen, a keypad, a number pad, an alpha-numeric keypad, a biometric scanner, a RFID reader, and/or the like to grant access to the delivery box interior space 120.

In one embodiment, the delivery box interior space 120 of the delivery box 100 may comprise a single compartment or multiple compartments. For example, as shown in FIG. 1, the interior space may be configured with multiple transport box receptacles 122. Each of the transport box receptacles 122 may be configured to receive a transport box 200. An additional space 126 may be provided for receiving goods not packaged in a transport box 200. The various compartments of the delivery box interior space 120 may be configured with a delivery box electrical contact 124. The delivery box electrical contacts 124 disposed within the delivery box interior space 120 of the delivery box 100 may be configured to come into contact with the transport box electrical contacts 208 disposed upon the transport box 200. The delivery box electrical contacts 124 may be configured to provide electrical power to the transport box 200. For example, the delivery box electrical contacts 124 may be configured to provide electrical power to transport box 200 to operate a cooling and/or heating system disposed on and/or within the transport box 200. Once coupled together, the delivery box electrical contacts 124 and the transport box electrical contacts 208 may also be configured to exchange information between the transport box 200 and the various other components of the variable destination delivery, such as the transport box controller circuit 250, the delivery box controller 150, and/or the Internet 20.

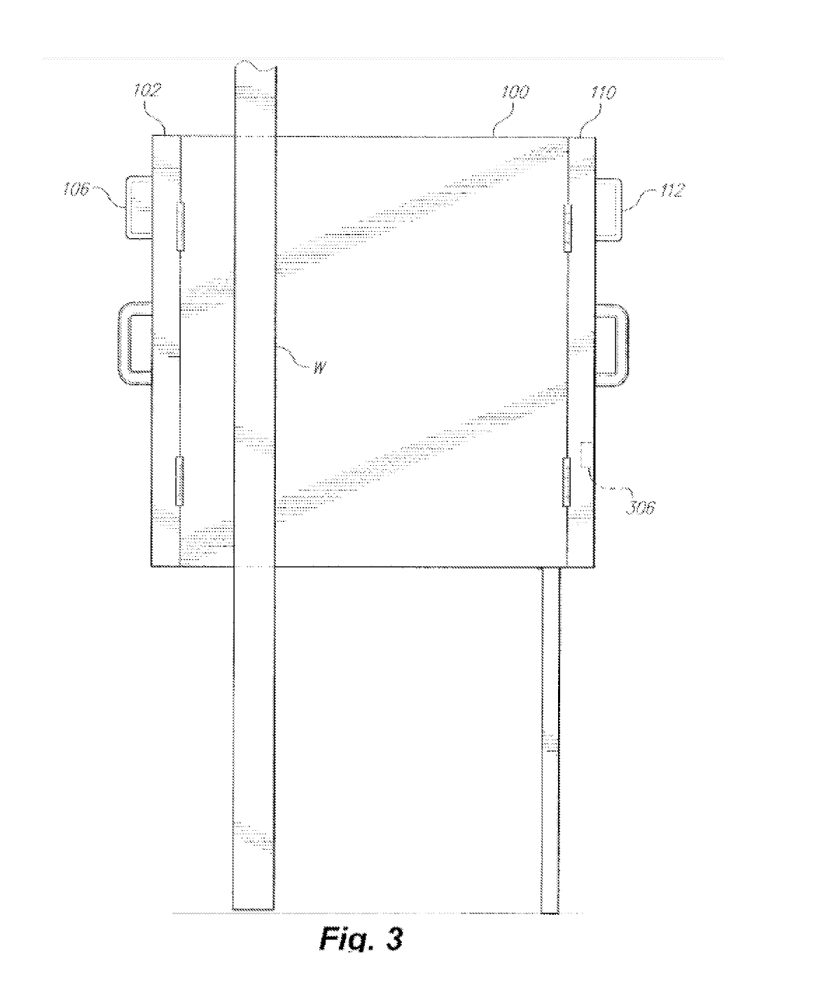

In one embodiment, the delivery box 100 may be configured to operate in a stand-alone configuration or in a wall-mounted pass-through configuration as shown in FIG. 3. In the stand-alone configuration, the delivery box 100 may be configured to grant and/or otherwise allow access to the delivery box interior space 120 by only the front door 102. In the wall-mounted pass-through configuration, the delivery box 100 may be configured to grant and/or otherwise allow access to the delivery box interior space 120 by the front door 102 and/or a second door 110.

In the wall-mounted pass-through configuration, the second door 110 may be configured to grant access to the delivery box interior space 120. The second door 110 may be configured to operate in conjunction with a second electronic lock 304. The second electronic lock 304 may be the same type, and operate in the same manner as the electronic lock 104. The second door 110 may be configured with a touch screen interface configured to operate the second electronic lock 304. The touch screen interface may be configured to receive inputs from a person, and operate various components of the variable destination delivery system based on the received inputs. For example, the touch screen interface may be configured to receive a passcode via an alphanumeric keypad to gain access to the delivery box interior space 120. The touchscreen interface may also be configured to receive biometric inputs as passcodes such as fingerprints, facial recognition, retina scans, voice recognition, and the like. The touchscreen interface may be further configured to receive and/or otherwise retrieve information from an RFID tag, an electronic device, a keycard, and or the like.

In one embodiment, the front door 102 and/or the second door 110 may be configured with any system or method configured to provide power to the delivery box 100, the transport box 200, and/or any other component of the variable destination delivery system. For example, solar panels may be configured to be disposed on the exterior portion of the delivery box 100. The solar panels may be configured to provide electrical power to any of the various components of the variable destination delivery system. For example, the solar panels may be configured to power the electronic locks 104, 304, the keycard reader 105, and the like.

In one embodiment, the delivery box 100 may be configured to be mounted on a vehicle. The delivery box 100 may be configured such that the front door 102 is utilized by a delivery person on the outside of the vehicle and the second door 110 may be configured to be utilized by a person on the inside of the vehicle. The delivery box 100 may be configured with any suitable system or method to be mounted on the vehicle. The delivery box 100 may be further configured with any suitable system or method to connect to the power supply of the vehicle. For example, the delivery box 100 may be configured with attachment sleeves that may be configured to connect a power source of the delivery box to the power source of the vehicle (for example, the vehicle battery). Once coupled together, the delivery box 100 may be configured to receive its power from the vehicle to power various components such as the heating device 258, the cooling device 256, the electronic locks 104, 304, and/or any other electrically powered component of the variable destination delivery system.

The front door 102 and/or the second door 110 may be configured to with any suitable system or method to display information. For example, an advertisement space may be designated on the exterior of the front door 102 of the delivery box 100. The advertisements may be in hard-copy form or in an electronic format. For example, a electronic display screen may be disposed on the exterior of the front door 102. The electronic display screen may be configured to display advertisement information and/or configured to display and/or convey any other type of media content.

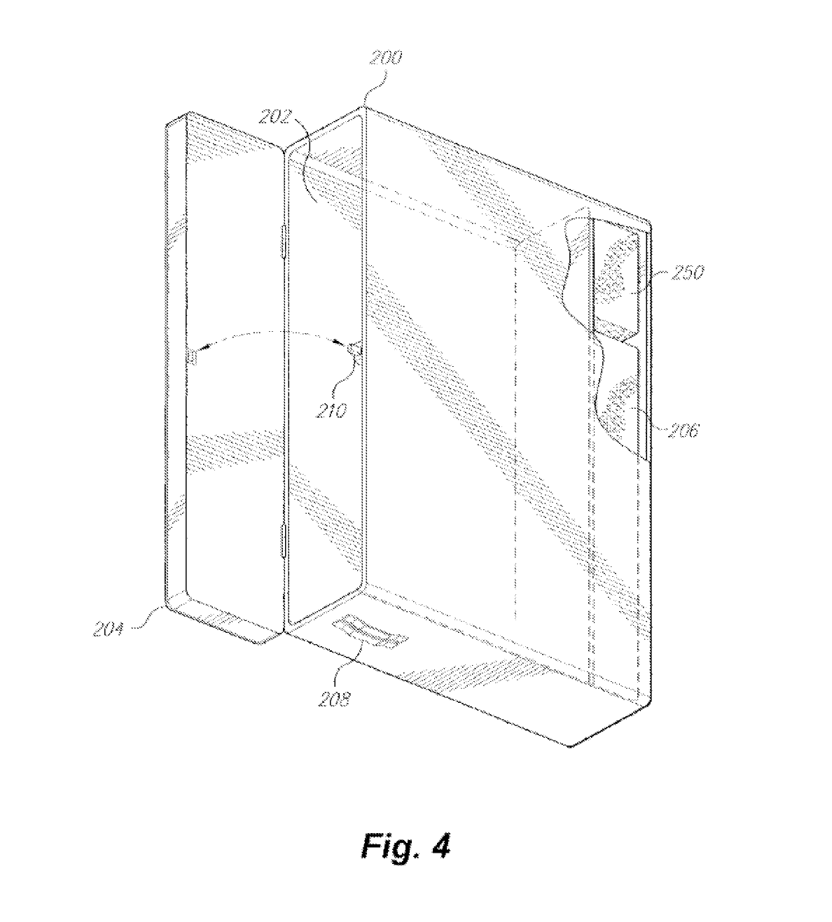

Now referring to FIG. 4, the transport box 200 may comprise any suitable system configured to receive goods for transport and/or shipment. For example, the transport box 200 may comprise a container having storage space 202 for receiving and storing goods for transport and/or shipment. The transport box 200 may be configured with a hinged and/or removable cover 204 which may be configured to allow access to the storage space 202. The transport box 200 may further comprise an environmental control module 206 configured to control the environment within the storage space 202. The environmental control module 206 may comprise any suitable system to monitor, adjust, and/or report the conditions of the storage space 202. For example, the environmental control module may be configured to operate a heating and/or cooling device to maintain and control the internal environment of the transport box. In one embodiment, a transport box controller circuit 250 may be configured to operate with the environment control module 206 to operate the environment control module 206 to maintain a predetermined environment within the storage space 202. Transport box electrical contacts 208 may be configured to be disposed on the outside of the transport box 200, and may be configured to operate in conjunction with the electrical contacts 124 of the transport box receptacle 122 within a delivery box 100. The environmental control module 206 may be configured to retrieve instructions from the transport box controller 250. For example, it may be the case that a particular shipment requires the shipment to occur at or below a certain temperature threshold, and this information may be downloaded to the transport box controller circuit 250 via the Internet 20. The transport box controller circuit may then utilize these instructions to control a heating device 258 and/or a cooling device 256 disposed on and/or within the transport box 200.

In one embodiment, a transport box controller circuit 250 may be configured to monitor the internal environment of the transport box. For example, temperature, humidity, pressure, and/or the like may be monitored. If the transport box controller circuit 250 determines that one of the parameters (e.g., temperature) has deviated beyond its normal and/or anticipated operating parameters, the transport box controller circuit may be configured to activate the cooling device 256 and/or the heating device 258 to bring the parameter back within its intended operating range or generate a signal bring the deviation to the attention of a delivery person or any other suitable person or system that may be able to take appropriate action to prevent the product being transferred from spoiling or going bad.

In one embodiment, the heating device 258 may comprise any suitable system or method configured to increase the ambient temperature of the storage space 202. The heating device 258 may be disposed internally within the storage space 202, externally on the body of the transport box 200 itself, and/or a combination of the two. The heating device 258 may be communicatively linked to the transport box controller circuit 250 such that information may be transmitted and received to and from the transport box 200 to the transport box controller circuit 250 and/or various other components of the variable destination delivery system. The transport box controller circuit 250 may be further configured to send instructions to the heating device 258. These instructions may comprise instructions to begin heating, stop heating, and/or the like. The heating device 258 may comprise a passive heating element such as a heat pad or an active heating element such as an electrically powered heater.

In one embodiment, the cooling device 256 may comprise any suitable system or method configured to decrease the ambient temperature of the storage space 202. The cooling device 256 may be disposed internally within the storage space 202, externally on the body of the transport box 200 itself, and/or a combination of the two. The cooling device 256 may be configured to comprise both the cooling device as well as the heating device 258. For example, the combined heating/cooling device may be configured to either lower the ambient temperature and/or increase the ambient temperature based on the current ambient temperature. The cooling device 256 may be communicatively linked to the transport box controller circuit 250 such that information may be transmitted and received to and from the transport box 200 to the transport box controller circuit 250 and/or various other components of the variable destination delivery system. The transport box controller circuit 250 may be further configured to send instructions to the cooling device 256. These instructions may comprise instructions to begin cooling, stop cooling, and/or the like. The cooling device 256 may comprise a passive cooling element such as an ice pack or an active cooling element such as an electrically powered cooler.

In one embodiment, an electronic locking mechanism 210 may be configured to operate in conjunction with the transport box controller circuit 250. For example, the transport box 200 may be configured to be locked until unlocked by the transport box controller circuit 250, such as when the transport box controller circuit 250 recognizes that the transport box 200 has been placed within a transport box receptacle 122 within a delivery box 100.

In one embodiment, the delivery box 100 may comprise a delivery box controller circuit 150. The delivery box controller circuit 150 may be configured to operate the electronic lock 104 of the front door 102 and/or the second electronic lock 304 of the second door 110. The delivery box controller 150 may also be configured to manage access and/or security codes and access to the delivery box interior space 120 of the delivery box 100. For example, the delivery box controller circuit 150 may be configured to exchange information back and forth with the Internet 20. One type of information exchanged may comprise the authorized code needed to operate the electronic locks 104, 304. For example, if the electronic locks 104, 304 are communicatively coupled to a keycard reader 106, then the delivery box controller 150 may be configured to perform authentication processes by verifying whether the keycard 105 read contains the proper authorizations. In another example, if the electronic locks 104, 304 are communicatively coupled to a biometric scanner, the delivery box controller 150 may be configured to retrieve biometric information to verify whether the access attempt is authorized.

In one embodiment, the delivery box electrical contacts 124 and the transport box electrical contacts 208 may be configured to come into contact with each other to establish a communication channel between the delivery box 100 and the transport box 200 such that information may be communicated back and forth via the communication interface 158. The communication interface 158 may also comprise a wireless communication interface 158 such that information may be communicated between the transport box 200, the delivery box 100, and various other components wirelessly. In another embodiment, a wireless method of communication may be utilized for communication between the delivery box controller circuit 150 of the delivery box 100 and the transport box controller circuit 250 contained in the transport box 200.

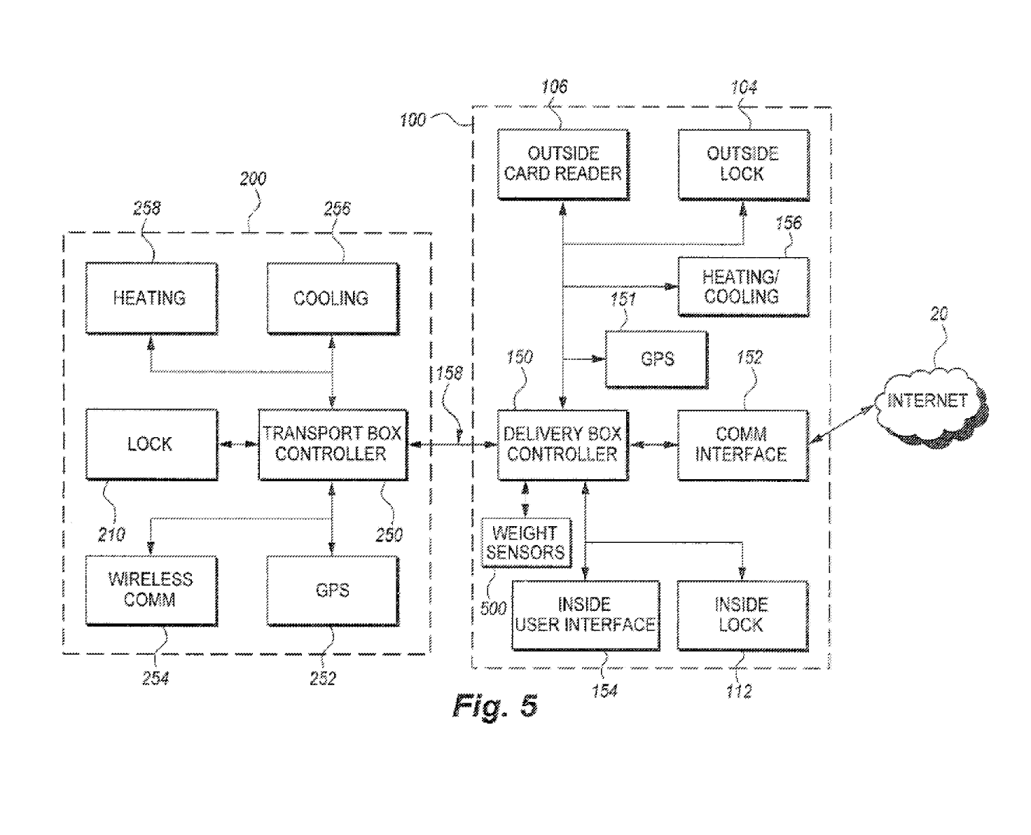

Now referring to FIG. 5, in one embodiment, a communication interface 158 may be configured to facilitate the communication and/or transfer of information between the transport box 200 and the delivery box 100. For example, the transport box controller circuit 150 and the delivery box controller circuit 250 may be configured to communicate, via the communication interface 158, information such as the GPS location of the transport box 200, the interior environment of the transport box 200, the electronic lock 104 of the delivery box, and/or various other components of the transport box 200 and/or the delivery box 100.

In one embodiment, the delivery box controller circuit 150 may be configured to communicate, via a communication interface 152, with the Internet 20. The communication interface 152 may be configured to utilize a wireless technology for remote communication. The delivery box controller circuit 150 may be further configured to be in communication with the card reader 106 and the electronic locks 104, 304. The delivery box controller circuit 150 may be configured to read and/or otherwise retrieve a security code from an electronic keycard 105 swiped through, or inserted into, the card reader 106. The delivery box controller circuit 150 may be configured to operate the electronic locks 104, 304 according the information read from the electronic keycard 105. The delivery box controller circuit 150 may be configured to be in communication with lock 112, and/or a user interface 154 such as a keypad, an electronic key reader, and/or the like configured to control or record user access to the delivery box. For example, the delivery box controller circuit 150 may be configured to keep a log of all attempts to access the delivery box electronic lock 104. The delivery box controller circuit 150 may be further configured to record the information used in the attempt to access the delivery box 100, such as the information relating to the date/time the access attempt was made, the GPS location of the access attempt, the keycard 105 used, the information entered into the user interface 154, and the like. The information recorded may be stored and/or transmitted to the customer, the merchant, and/or the shipping company.

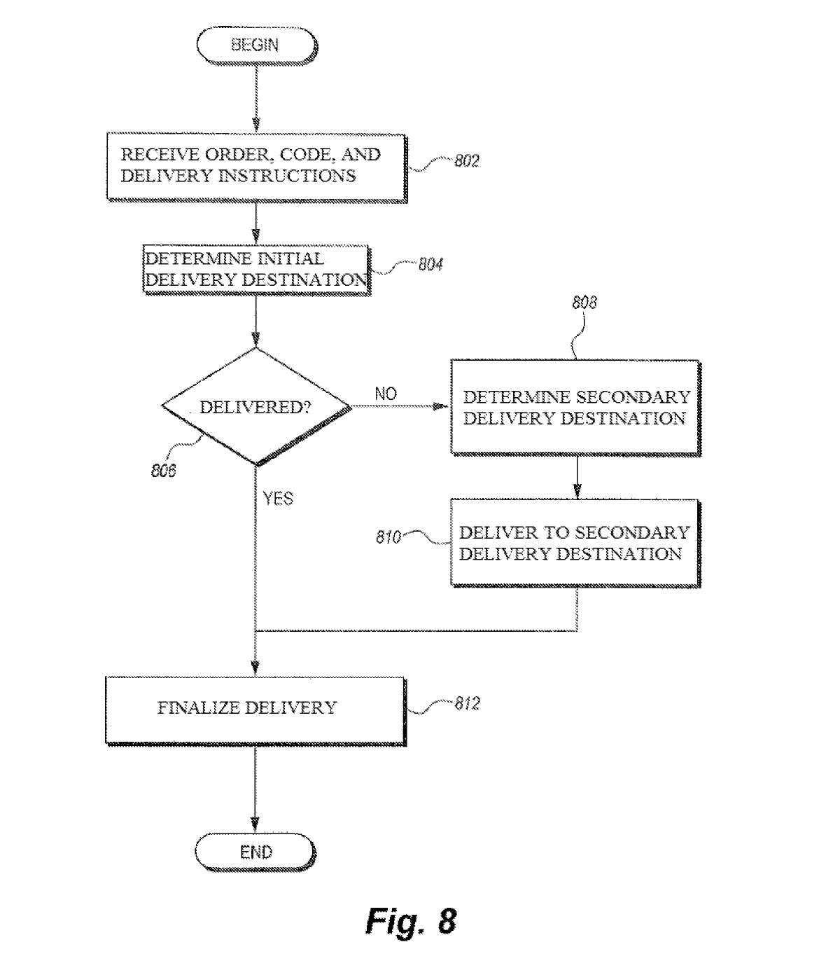

Now referring to FIGS. 5 and 8, in one embodiment, the delivery box controller circuit 150 may be communicatively linked to a delivery box Global Positioning System (GPS) receiver 151. The delivery box GPS receiver 151 may be configured to determine and/or provide the geographical location of the delivery box 100 for delivery purpose (e.g., tracking). The delivery box controller circuit 150 may be configured to receive information related to an order (802) such as the items to be shipped and/or transported, information required to access the electronic locks 104, 304, and/or a set of delivery instructions. The variable destination delivery system may be configured to determine an initial delivery destination (e.g., a street address or a specific location) (804). The initial delivery destination may be inputted, downloaded, uploaded, transferred, and/or otherwise be linked to the delivery box controller circuit 150. For example, when the customer first places an order for items to be shipped and/or transported, the customer may provide the shipping company with a specific address to deliver the shipment to as the initial delivery destination. The initial delivery destination may then be downloaded onto the delivery box controller circuit 150, which is configured to retrieve the initial delivery destination.

In one embodiment, the initial delivery destination may comprise the location of the GPS-enabled electronic device from which the customer used to place an order. For example, a customer may order a pizza using their smart phone or tablet, and the variable destination delivery system may be configured to retrieve the current GPS location of the GPS-enabled electronic device used to place the order and use that as the initial delivery destination.

In one embodiment, if the variable destination delivery system may be configured to determine a secondary delivery destination (808) if it is determined that the initial delivery destination is no longer appropriate and/or the shipment could not be delivered to the initial delivery destination (806). The secondary delivery destination may be configured to be the destination to which the shipment should be delivered (810) in the chance that the initial delivery destination is no longer appropriate. Once the delivery has been completed (to either the initial delivery destination or the secondary delivery destination), the delivery may be finalized (812). Finalizing the delivery may comprise updating the variable destination delivery system to indicate that the shipment has been delivered.

In one embodiment, the delivery box control circuit 150 may be configured to receive information relating to a secondary delivery destination. The secondary delivery destination may be dynamic or static. For example, the secondary delivery destination may be dynamic based on the location of a GPS-enabled electronic device or the secondary delivery destination may be static based on the location of a specific address and/or location. The secondary delivery destination may be a default delivery destination determined by the customer when they place their order.

In one embodiment, the delivery box control circuit 150 may be configured to receive specific shipping instructions, including time constraints, temperature constraints, and the like. For example, if the shipment requires a certain temperature threshold not be passed, the delivery box controller circuit 150 may be configured to communicate with the transport box controller circuit 250 to ensure that the temperature threshold is maintained by operating either the heating device 258 and/or the cooling device 256.

In one embodiment, the delivery box controller circuit 150 may comprise a microcomputer or microcontroller, and/or any other type of programmable logic device, and/or a memory for storing programming instructions and the like.

In one embodiment, the transport box controller circuit 250 may comprise a transport box Global Positioning System (GPS) receiver 252. The transport box 200 may further comprise a wireless communications interface 254 such as Bluetooth®, wireless Ethernet (802.11b) or a similar technology. The transport box controller circuit 250 may be configured to be communicatively linked with the various components of the transport box, such as the transport box GPS receiver 252, the wireless communication interface 254, the electronic locking mechanism 210, the transport box heating module 258, and/or the transport box cooling module 256. The transport box controller circuit 250 may comprise a microcomputer or microcontroller, and/or other type of programmable logic device, and/or a memory for storing programming instructions.

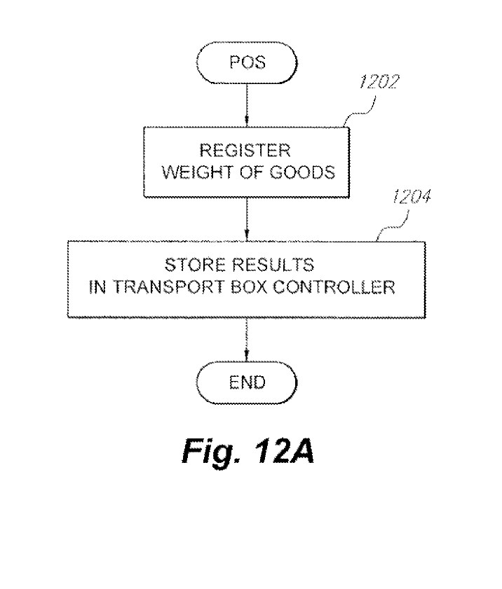

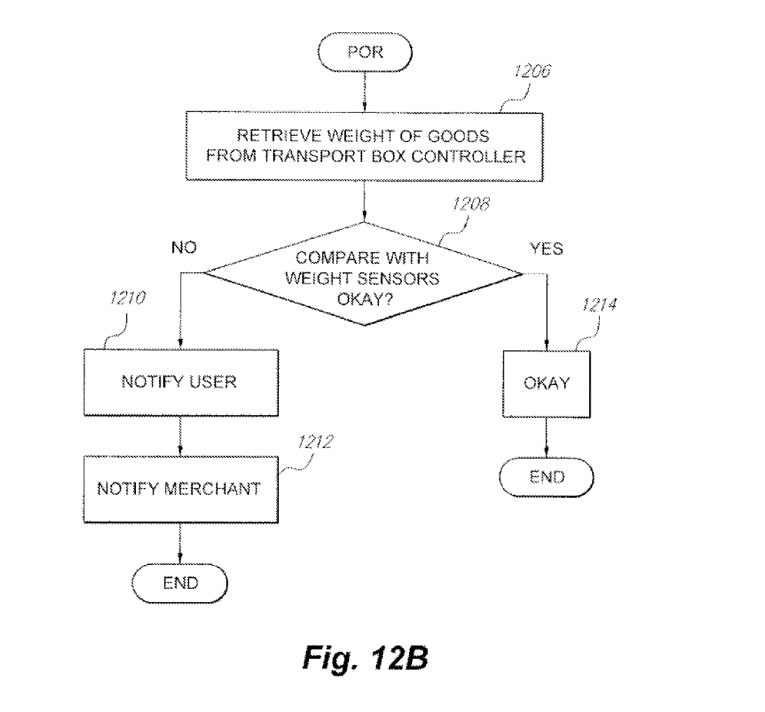

Now referring to FIG. 12A, in one embodiment, weight sensors 500 may be disposed within the delivery box 100. The weight sensors may be configured to communicate with the delivery box controller circuit 150. The weight sensors may be further configured to weigh the weight of the goods to be delivered and/or transported and may then registered the information (1202) at the point of sale (POS) and transmit the information to the transport box controller circuit 250 (1204). The delivery box controller circuit 150 may be configured to compare the weight of the delivered goods at the point of reception (POR), i.e., at the delivery box 100, with the weight of the delivery goods recorded at the point of sale.

Now referring to FIG. 12B, in one embodiment, the POR processing entails the POS weight of goods being retrieved from the transport box controller circuit 250 (1206) and compared with the information received from the weight sensors 500 (1208). Any weight discrepancy may result in a notification being generated to notify the customer (1210) and/or the merchant (1212). If the weight is included in the shipping instructions, the goods delivery may be rejected based on non-compliance with the shipping instructions due to weight discrepancy. Otherwise, an all-clear (e.g., status is okay) notification may be generated (1214).

In one embodiment, the delivery box 100 and/or the transport box 200 may be configured with any suitable system for tracking, logging, and/or managing the inventory of delivery boxes 100 and/or transport boxes 200. For example, each of the delivery boxes 100 and transport boxes 200 may be configured with a unique serial number. The variable destination delivery system may be configured to keep a log of all the delivery boxes 100 and/or transport boxes 200 currently assigned to an entity. The serial numbers may be referenced by the variable destination delivery system to determine the geographical location of the delivery box 100 and/or transport box 200.

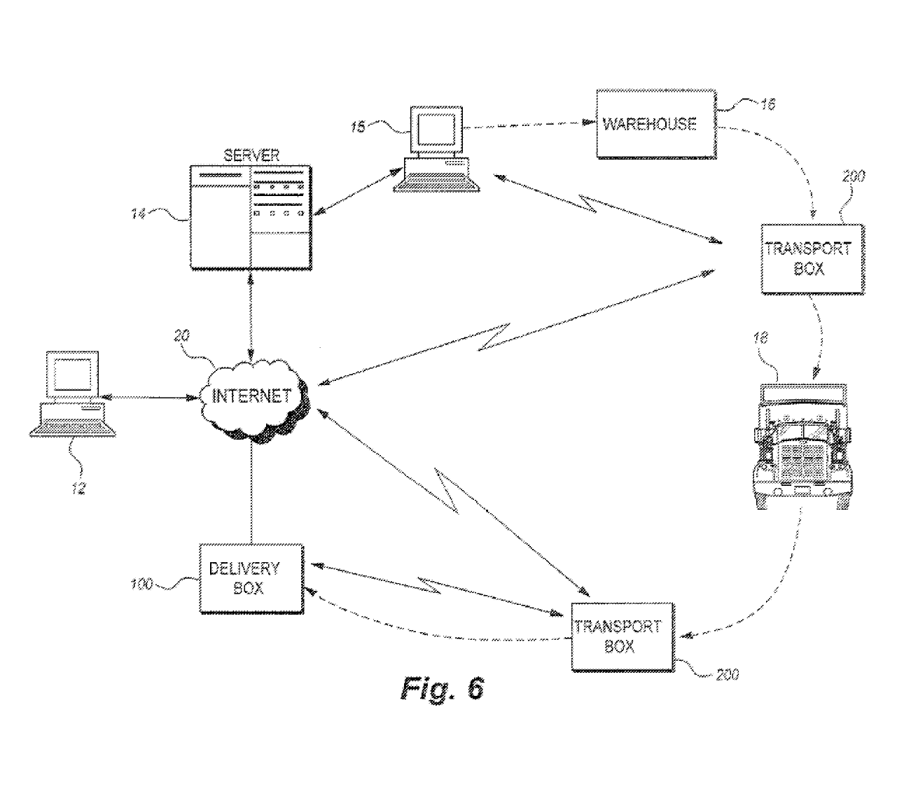

Now referring to FIG. 6, the variable destination delivery system may be configured to utilize a delivery box 100, wherein the delivery box 100 may be configured to be in communication with the Internet 20. A customer using an electronic device 12 to access the Internet 20 may browse the World Wide Web seeking an Internet merchant of desired goods. Once the desired goods have been located, the user may place an order for delivery of those goods to the customer's delivery box 100.

An Internet merchant server 14 may be configured to be in communication with the Internet 20, and further configured to receive a customer order for goods, along with delivery instructions for the goods, and may be configured to dispatch the order for fulfillment to a warehouse 16, such as by way of vendor or warehouse computer 15 in communication with the server 14 via the Internet 20. An identification or security code may be generated for the order, and a keycard 105 may be created bearing a code in an electronically readable format. The goods may be packaged into a transport box 200, and electronic delivery instructions may be downloaded into the transport box controller circuit 250 of the transport box 200, along with the keycard 105.

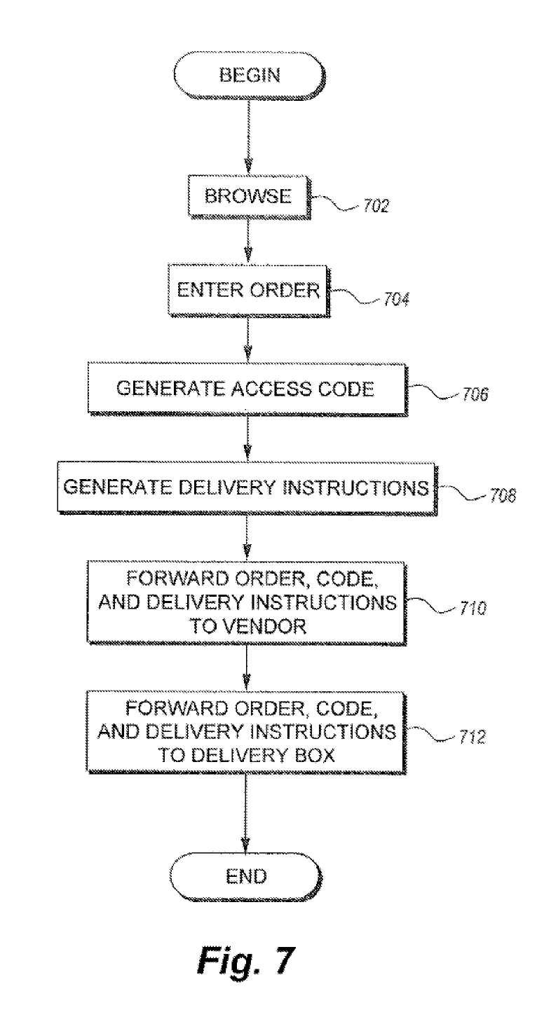

Now referring to FIG. 7, a method for entering an order by a customer may comprise browsing the Internet 20, and particularly a merchant Web site, to locate goods for purchase (702). With goods selected, an order may be entered (704), identifying an initial delivery destination. The order entry may comprise completion of a payment transaction, wherein the customer enters payment information such as a credit card number or appropriate identification for another online payment service.

Once the order is entered, and payment confirmed, the variable destination delivery system may be configured to generate a unique delivery instruction and/or access code (706). The delivery instruction may be downloaded and/or otherwise transferred to the delivery box controller circuit 150. A keycard 105 may also be generated and/or imprinted with information containing the delivery instructions or access code. The delivery code may be configured to function as a security code for access to the delivery box 100, and also may be configured to track and/or modify the order. For example, if the customer placed an order for pizza using their electronic device, the initial delivery destination may comprise the location of the customer's GPS-enabled electronic device. If the customer wishes to change their delivery to a secondary delivery destination, the variable destination delivery system may be configured to allow the user to change the delivery destination by providing the delivery code.

In one embodiment, separate (i.e., different) security and tracking codes may be used. Codes may be encrypted for distribution, over the Internet, to the merchant and the delivery box 100. Delivery instructions may be generated (708). The delivery instructions may include electronic delivery instructions that are downloadable into the delivery box controller circuit 150. The delivery instructions may be configured to comprise information identifying special handling for the goods that will be shipped and/or transported by the delivery box 100 and/or transport box 200.

In one embodiment, the delivery instructions may comprise temperature or environmental parameters to be maintained by the delivery box 100 and/or transport box 200. The delivery instructions may also comprise security instructions such as a geographic area or GPS location where delivery is to occur. The delivery instructions may also comprise a due date, time deadline, and/or an expiration time for the order.

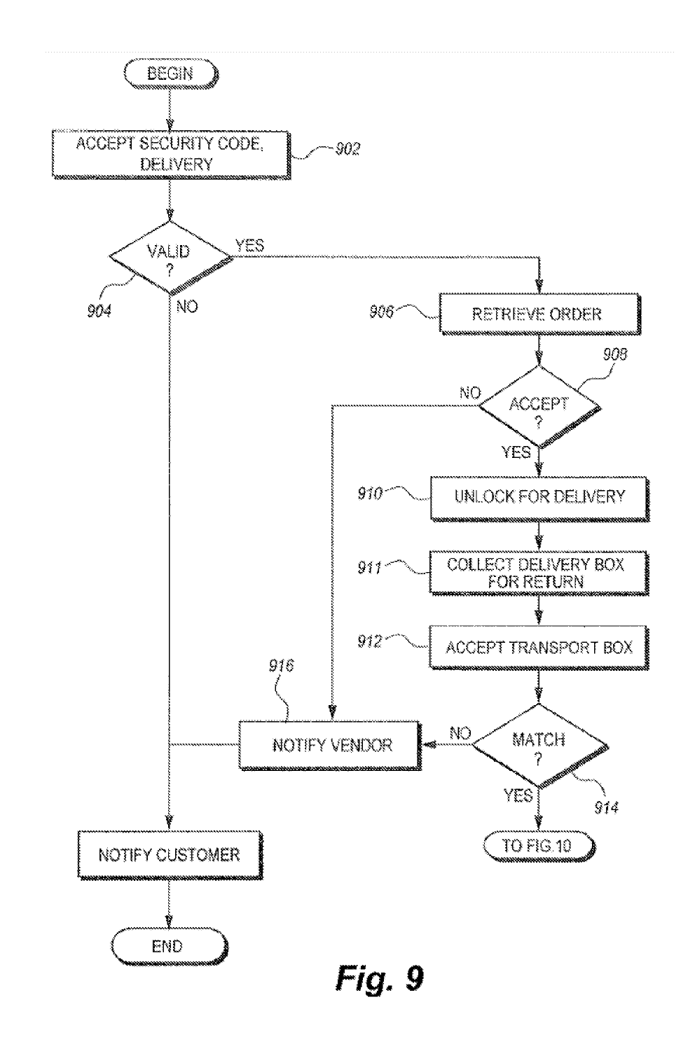

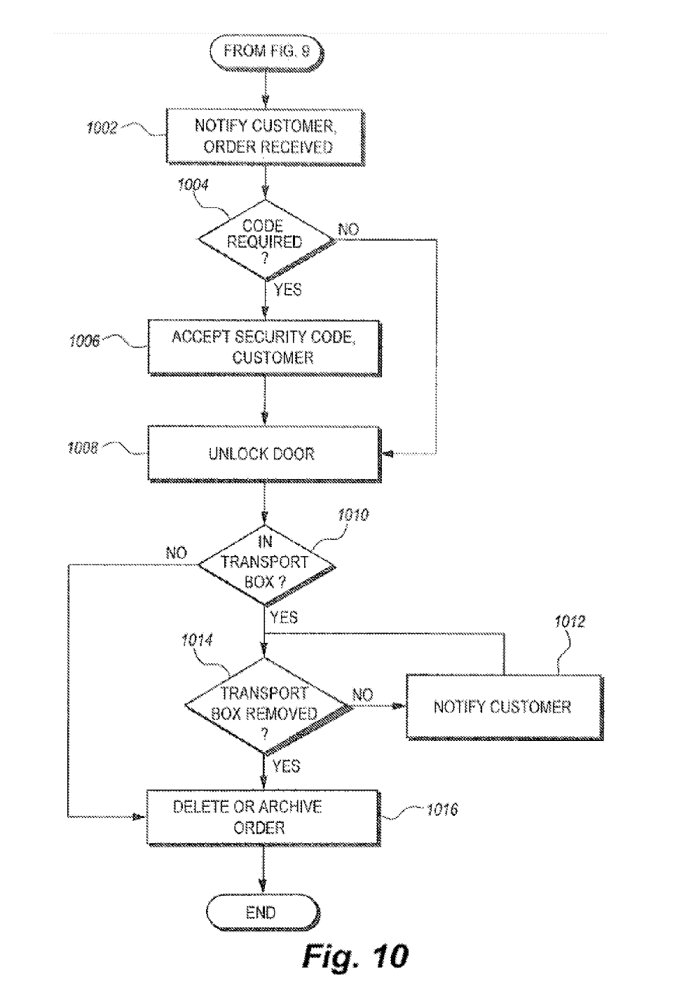

Now referring to FIGS. 9 and 10, in one embodiment, granting access to the delivery box 100 may comprise first authenticating and/or authorizing a security code (902). If the code read is not a valid code (904), the delivery box controller circuit 150 may be configured to not activate and/or otherwise prevent the electronic lock 104 from granting access to the delivery box interior space 120 of the delivery box 100. Instead, in the event of a wrong and/or unauthorized code entry, a notification may be generated to alert the customer that an unauthorized or unexpected attempt to open the delivery box 100 was made (918).

In one embodiment, if a valid security code is read, the delivery box controller circuit 150 may be configured to grant access to the interior space 102 so that the goods may be retrieved (906) along with any delivery instructions for the order. The order may be accepted or rejected (908) depending on whether or not the delivery of goods complies with the delivery instructions. For example, delivery instructions for an order may have specified a delivery deadline that has been missed. If the order is rejected, a notification may be sent to the vendor (or shipper) (916), and the customer may also be notified (918). If the order is accepted, the delivery box controller circuit 150 may be configured to operate the electronic locks 104, 304 to open (910) and/or otherwise grant access to the delivery box interior space 120 of the delivery box 100.

If the goods to be delivered and/or transported are stored in a transport box 200, the transport box 200 may be placed into a transport box receptacle 122 (912) within the delivery box 100. In this manner, the transport box electrical contacts 208 may be configured to come into contact with the delivery box electrical contacts 124. Goods delivered and/or transported without a transport box 200 may be placed in the additional space 126 of the delivery box 100.

In one embodiment, a transport box 200 placed into a transport box receptacle 122 may cause the transport box controller circuit 250 of the transport box 200 may be communicatively linked with the delivery box controller circuit 150 of the delivery box 100. The order and delivery instructions stored in the transport box 200 may be compared against the order and delivery instructions stored in the delivery box 100 to verify that the correct order has been received. If there is a mismatch (914), an alert may be generated, and the vendor may be notified (916) and the customer may be notified (918).

Now referring to FIG. 10, the delivery box controller circuit 150 may be configured to generate an alert to notify the customer of the delivery of the goods (1002). In one embodiment, the customer may be required to enter a security code to gain access to the goods within the delivery box 100. In a delivery box 100 configured with only a front door 102 for access, the customer may need to enter a code to unlock the front door 102. Similarly, if a second door 110 is configured with a second electronic lock, a security code (which may be the same code or a different code) may be required for the customer to gain entry to the second door 110. If a security code is required (1004), the customer may enter the code, and the delivery box control circuit 150 of the delivery box 100 may be configured to read the security code. If a valid code is entered, the delivery box controller circuit 150 may be configured to grant access to the delivery box interior space 120 of the delivery box 100.

In one embodiment, if the goods are not in a transport box 200, the order and delivery instructions may be deleted and/or archived (1016) once access is granted to the delivery box interior space 120 of the delivery box 100. If the goods are contained within a transport box 200, the order and delivery instructions may be retained and/or otherwise stored until the transport box 200 is removed from its transport box receptacle 122. If the transport box 200 is not timely removed from the transport box receptacle 122 after access to the delivery box interior space 120 the delivery box 100 is granted (1014), a reminder may be generated to notify the customer (step 1012). Once the transport box 200 is removed, the order and delivery instructions may be deleted and/or archived (1016).

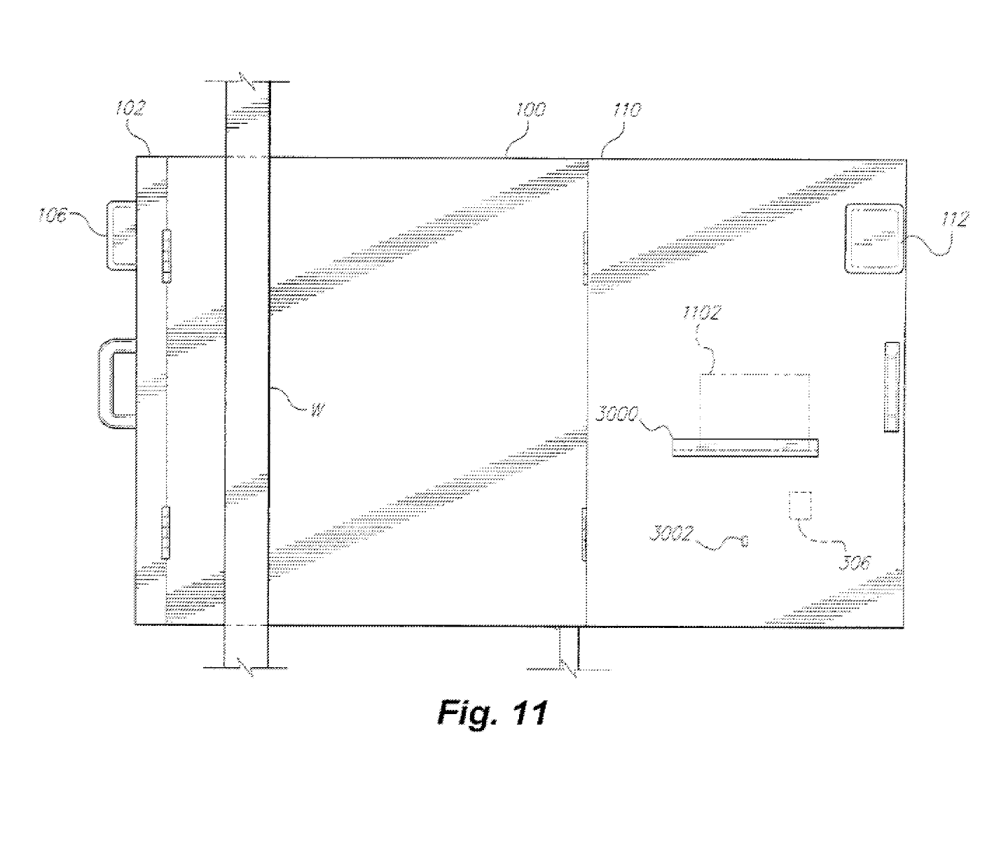

Now referring to FIG. 11, in an alternative embodiment, a PC pluggable interface 3002 may be disposed on the inside of the second door 110 of the delivery box 100. The PC pluggable interface 3002 may be configured to communicatively link an electronic device with the delivery box 100. For example, the PC pluggable interface 3002 may be configured to link a cell phone, a tablet, a laptop, and/or the like to the delivery box 100. Once coupled to the PC pluggable interface, the electronic device may be configured to operate various components of the variable destination delivery system such as the heating device 258, the cooling device 256, the electronic locks 104, 304, the delivery box controller circuit 150, the transport box controller circuit 250, and/or the like. For example, the electronic device may be configured to lock and/or unlock the electronic locks 104, 304 via the PC pluggable interface 3002.

A slotted tablet attachment bar 3000 may be configured to be disposed on the second door 110 of the delivery box 100. The slotted tablet attachment bar 3000 may be configured such that a wireless tablet 1102 may be retained by the slotted tablet attachment bar 3000. The delivery box controller circuit 150 may be configured to communicate with the tablet 1102. For example, the wireless tablet 1102 may be configured to send and receive instructions to and from the delivery box controller circuit 150 to operate various components of the variable destination delivery system such as the heating device 258, the cooling device 256, the GPS receivers 252, 151, and or the like.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A variable destination delivery system for an item ordered by a user having a GPS-enabled electronic device configured to communicate over a network, comprising:
a transport box communicatively linked to the network and configured to receive an item to be shipped within a transport box storage space, wherein the transport box comprises:
a transport box controller circuit communicatively coupled to the transport box, wherein the transport box controller circuit is configured to receive information comprising:
an initial delivery destination determined according to an input from the user's GPS-enabled electronic device;
a secondary delivery destination determined according to a default destination setting; and
an instruction set for the items to be shipped; and
a GPS receiver communicatively linked to the transport box controller circuit;
an environmental control module communicatively coupled to the transport box controller circuit, wherein the environmental control module is configured to monitor and adjust an interior condition of the interior space of the transport box; and
a delivery box communicatively linked to the network and configured to communicate with the transport box, wherein the delivery box comprises:
a delivery box controller circuit communicatively coupled to the delivery box, wherein the delivery box controller circuit is configured to receive information comprising a security code to operate an electronic lock disposed on an exterior front door of the delivery box; and
a delivery box interior space configured to receive the transport box; and
a communication interface configured to communicatively link the transport box controller circuit and the delivery box controller circuit, wherein the communication interface is configured to facilitate the exchange of information between the transport box and the delivery box.

2. The variable destination delivery system of claim 1, further comprising:
a transport box electrical contact disposed on the transport box; and
a delivery box electrical contact disposed on the delivery box, wherein the transport box electrical contact and the delivery box electrical contact are configured to be coupled to each other to form a communication link between the transport box controller circuit and the delivery box controller circuit.

3. The variable destination delivery system of claim 1, wherein the transport box further comprises:
a heating device configured to increase the ambient temperature of the storage space of the transport box; and
a cooling device configured to decrease the ambient temperature of the storage space of the transport box, wherein the heating device and cooling device are configured to be communicatively linked to transport box controller circuit such that information may be transmitted to and receive from the heating and cooling device to the transport box controller circuit.

4. The variable destination delivery system of claim 1, wherein the delivery box further comprises:
a heating device configured to increase the ambient temperature of the interior space of the delivery box; and
a cooling device configured to decrease the ambient temperature of the interior space of the delivery box, wherein the heating device and cooling device are configured to be communicatively linked to delivery box controller circuit such that information may be transmitted to and receive from the heating and cooling device to the delivery box controller circuit.

5. The variable destination delivery system of claim 1, further comprising a communication interface module communicatively coupled to the delivery box controller circuit, wherein the communication interface module is further configured to be communicatively linked to the Internet.

6. The variable destination delivery system of claim 1, wherein the instruction set for the items to be shipped is configured to be stored on at least one of the delivery box controller circuit or the transport box controller circuit.

7. The variable destination delivery system of claim 6, wherein the instruction set for the items to be shipped further comprises a temperature threshold for the items to be shipped.

8. The variable destination delivery system of claim 1, wherein the delivery box may further comprise:
a rear door disposed on an opposing side of the exterior front door; and
a second electronic lock disposed on the exterior of the rear door, wherein the second electronic lock is configured to operate the second electronic lock.

9. The variable destination delivery system of claim 8, further comprising an input device disposed on the rear door, the input device configured to:
receive an input;
validate the input; and
operate the second electronic according to the input received.

10. A variable destination delivery system, comprising:
a transport box comprising a storage space configured to receive an item for shipment, the transport box further comprising:
a transport box controller circuit; and
a plurality of electrical contacts disposed on the transport box;
a delivery box configured to receive the transport box within a delivery box interior space, wherein the delivery box further comprises:
a delivery box controller circuit configured to receive a shipment information over a network;
a plurality of electrical contacts disposed on the delivery box, wherein the electrical contacts of the delivery box is configured to be coupled to the electrical contacts of the transport box;
an electronic lock disposed on an exterior front door of the delivery box, the electronic lock configured to control access to the delivery box interior space; and
an input device communicatively coupled to the electronic lock, wherein the input device is configured to operate the electronic lock upon the occurrence of a valid input; and
a communication interface configured to communicatively link the transport box controller circuit and the delivery box controller circuit such that information may be transmitted via the communication interface.

11. The variable destination delivery system of claim 10, wherein the transport box further comprises:
a heating device configured to increase the ambient temperature of the storage space of the transport box; and
a cooling device configured to decrease the ambient temperature of the storage space of the transport box, wherein the heating device and cooling device are configured to be communicatively linked to transport box controller circuit such that information may be transmitted to and receive from the heating and cooling device to the transport box controller circuit.

12. The variable destination delivery system of claim 10, wherein the delivery box further comprises:
a heating device configured to increase the ambient temperature of the interior space of the delivery box; and
a cooling device configured to decrease the ambient temperature of the interior space of the delivery box, wherein the heating device and cooling device are configured to be communicatively linked to delivery box controller circuit such that information may be transmitted to and receive from the heating and cooling device to the delivery box controller circuit.

13. The variable destination delivery system of claim 10, wherein the instruction set for the items to be shipped further comprises a temperature threshold for the items to be shipped.

14. The variable destination delivery system of claim 10, wherein the delivery box may further comprise:
a rear door disposed on an opposing side of the exterior front door; and
a second electronic lock disposed on the exterior of the rear door, wherein the second electronic lock is configured to operate the second electronic lock.

15. The variable destination delivery system of claim 14, further comprising an input device disposed on the rear door, the input device configured to:
receive an input;
validate the input; and
operate the second electronic according to the input received.

16. A computer-implemented method of ordering items to be shipped over a network using a variable destination delivery system, the method comprising:
downloading, over a network, an instruction set for the items to be shipped, wherein the instruction set is configured to be stored on a delivery box controller circuit;
determining, by the delivery box controller circuit, an initial shipment destination, wherein the initial shipment destination may comprise the geographical location from which the shipment was ordered;
configuring a transport box to receive the items to be shipped;
configuring a delivery box to receive the transport box, wherein receiving the transport box may comprise coupling a delivery box electrical contact with a transport box electrical contact;
establishing a communication interface between the delivery box and the transport box by communicatively linking a transport box controller circuit to a delivery box controller circuit;
monitoring the internal environmental conditions of the transport box and the delivery box during shipping;
adjusting the internal environmental conditions of the transport box and the delivery box according to the instruction set, wherein adjusting the internal environmental conditions further comprises operating, via the delivery box controller circuit or the transport box controller circuit, a heating device or a cooling device; and
accessing, via an electronic lock disposed on the delivery box, the delivery box interior space the delivery box.

17. The computer-implemented method of ordering items to be shipped of claim 16, wherein configuring the transport box comprises:
configuring a heating device to increase the ambient temperature of the storage space of the transport box; and
configuring a cooling device to decrease the ambient temperature of the storage space of the transport box, wherein the heating device and cooling device are configured to be communicatively linked to the transport box controller circuit such that information may be transmitted to and receive from the heating and cooling device to the transport box controller circuit.

18. The computer-implemented method of ordering items to be shipped of claim 16, wherein configuring the delivery box further comprises:
configuring a heating device to increase the ambient temperature of the interior space of the delivery box; and
configuring a cooling device configured to decrease the ambient temperature of the interior space of the delivery box, wherein the heating device and cooling device are configured to be communicatively linked to delivery box controller circuit such that information may be transmitted to and receive from the heating and cooling device to the delivery box controller circuit.

19. The computer-implemented method of ordering items to be shipped of claim 16, wherein the instruction set for the items to be shipped further comprises a temperature threshold for the items to be shipped.

20. The computer-implemented method of ordering items to be shipped of claim 17, wherein the instruction set for the items to be shipped further comprises:
an initial delivery destination determined according to an input from a GPS-enabled electronic device; and
a secondary delivery destination determined according to a default destination setting.
